(19) United States
(12) Patent Application Publication
(10) Pub. No.: US 2007/0097049 A1
(43) Pub. Date: May 3, 2007

(54) In-vehicle liquid crystal display device with temperature sensor

(75) Inventor: Wen-Hui Yao, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/590,700

(22) Filed: Oct. 30, 2006

(30) Foreign Application Priority Data
Oct. 28, 2005 (TW) 94218708

(51) Int. Cl. G09G 3/36

(52) U.S. Cl. 345/87

(57) ABSTRACT

An exemplary in-vehicle LCD device (100) includes a temperature sensor (101), a power circuit selector (102), a power circuit (103), a reverse power circuit (105), a Peltier member (106), and a LCD module (107) having the Peltier member operatively coupled thereto. The temperature sensor, the power circuit selector, the power circuit, the Peltier member, and the LCD module are electrically connected series, and the reverse power circuit is electrically connected between the power circuit selector and the Peltier member. The in-vehicle LCD device can automatically control the Peltier member to be in either one of the normal and reverse operation states or be turned off, according to the environmental temperature detected by the temperature sensor. Therefore the operational temperature of the LCD module can be adjusted to be in the normal range.

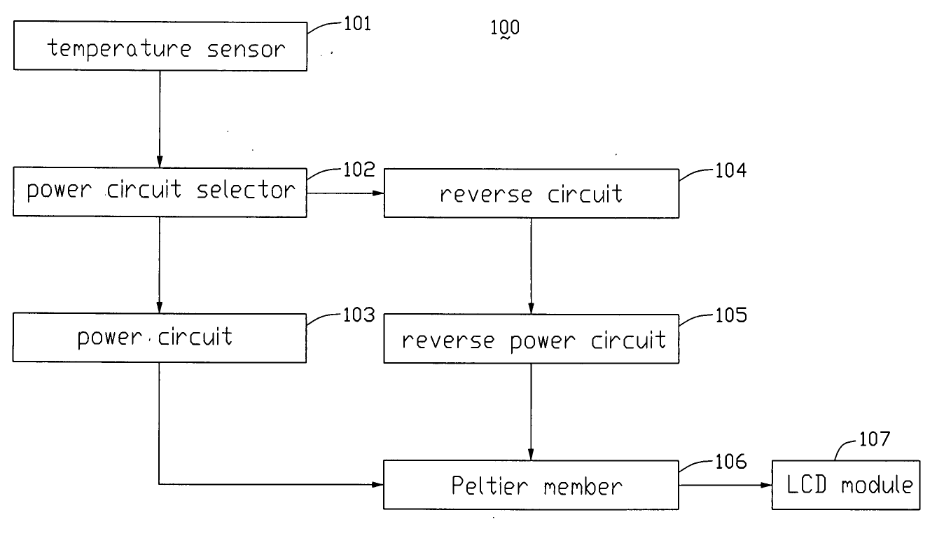

### FIELD OF THE INVENTION

The present invention relates to in-vehicle liquid crystal display (LCD) devices, and more particularly to an in-vehicle LCD device having a temperature sensor.

### BACKGROUND

Because LCD devices have the advantages of portability, low power consumption, and low radiation, they have been widely used in various portable information products such as notebooks, personal digital assistants (PDAs), video cameras, and the like. Furthermore, LCD devices are considered by some to have the potential to completely replace CRT (cathode ray tube) monitors and televisions.

LCD devices are also applied in all kinds of motor vehicles, where they are known as in-vehicle LCD devices. The motor vehicles may run in all kinds of environments with different temperatures; for example, higher than 35° C. in the summer, or lower than 0° C. in the winter. That is, the in-vehicle LCD devices may need to operate in environments subject to extreme weather conditions. However, the LCD module of a typical in-vehicle LCD device has a range of normal operating temperatures. If the prevailing environment temperature is out of this range, the display quality of the LCD module may be impaired, and the LCD device may even fail altogether.

Accordingly, what is needed is an in-vehicle LCD device that can overcome the above-described deficiencies.

### SUMMARY

In one aspect, an in-vehicle LCD device includes a temperature sensor, a power circuit selector, a power circuit, a reverse power circuit, a Peltier member, and an LCD module having the Peltier member operatively coupled thereto. The temperature sensor, the power circuit selector, the power circuit, the Peltier member, and the LCD module are electrically connected series. And the reverse power circuit is electrically connected between the power circuit selector and the Peltier member.

In another aspect, an in-vehicle LCD device includes a temperature sensor; a power circuit selector electrically connected to the temperature sensor; a peltier member; a first power circuit and a second power circuit electrically connected in parallel between the power circuit selector and the peltier member; and an LCD module electrically connected to the peltier member, and having the peltier member operatively coupled thereto.

Other advantages and novel features will become more apparent from the following detailed description when taken in conjunction with the accompanying drawing.

### BRIEF DESCRIPTION OF THE DRAWING

The drawing is a block diagram of an in-vehicle LCD device according to an exemplary embodiment of the present invention.

### DETAILED DESCRIPTION OF PREFERRED EMBODIMENTS

Reference will now be made to the drawings to describe preferred and exemplary embodiments of the present invention in detail.

Referring to the drawing, an in-vehicle LCD device 100 includes a temperature sensor 101, a power circuit selector 102, a power circuit 103, a reverse circuit 104, a reverse power circuit 105, a Peltier member 106, and an LCD module 107.

The temperature sensor 101, the power circuit selector 102, the power circuit 103, the Peltier member 106, and the LCD module 107 are electrically connected one by one in series. Further, the power circuit selector 102 is electrically connected with the reverse circuit 104, the reverse circuit 104 is electrically connected with the reverse power circuit 105, and the reverse power circuit 105 is electrically connected with the Peltier member 106.

In operation, the temperature sensor 101 detects a temperature of the environment that the in-vehicle LCD device 100 is currently in, and transmits a signal representing a value of the environmental temperature to the power circuit selector 102. The power circuit selector 102 compares the environmental temperature with a critical high temperature and a critical low temperature stored therein. That is, the high and low critical temperatures are input to the power circuit selector 102 in advance, according to a normal operational temperature range of the LCD module 107. If the environmental temperature is higher than the critical high temperature of the LCD module 107, the power circuit selector 102 turns on the power circuit 103 to make the Peltier member 106 operate in a reverse operational state. At this time, the Peltier member 106 is maintained in a heat discharging state in order to rapidly discharge heat from the LCD module 107 and bring the LCD module 107 within its normal operational temperature range. On the other hand, if the environmental temperature is lower than the critical low temperature of the LCD module 107, the power circuit selector 102 turns on the reverse circuit 104 and the reverse power circuit 105 to make the Peltier member 106 operate in a normal operational state. At this time, the Peltier member 106 is maintained in a heat generating state in order to increase the operational temperature of the LCD module 107 and bring the LCD module 107 within its normal operational temperature range. If the environmental temperature is in the range between the critical high temperature and the critical low temperature, the power circuit selector 102 does not turn on any of the power circuit 103, the reverse circuit 104, and the reverse power circuit 105. That is, the Peltier member 106 is in an off state. This saves on power consumption of the in-vehicle LCD device 100.

With this configuration, the in-vehicle LCD device 100 can automatically control the Peltier member 106 to be in either one of the normal and reverse operation states or be turned off, according to the environmental temperature detected by the temperature sensor 101. Therefore the operational temperature of the LCD module 107 can be adjusted to be in the normal range. The in-vehicle LCD device 100 may be employed in environments subject to all kinds of temperature variations, with the LCD module 107 being able to consistently provide a high quality, reliable display.

In a further or alternative embodiment of the in-vehicle LCD device 100, the temperature sensor 101 may be used to detect the operational temperature of the LCD module 107. In such case, the power circuit selector 102 controls the power circuit 103, the reverse circuit 104, and the reverse power circuit 105 having regard to or according to the operational temperature of the LCD module 107.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An in-vehicle liquid crystal display device, comprising:
a temperature sensor;
a power circuit selector;
a power circuit;
a reverse power circuit;
a Peltier member; and
a liquid crystal display module having the Peltier member operatively coupled thereto;
wherein the temperature sensor, the power circuit selector, the power circuit, the Peltier member, and the liquid crystal display module are electrically connected in series, and the reverse power circuit is electrically connected between the power circuit selector and the Peltier member.

2. The in-vehicle liquid crystal display device as claimed in claim 1, further comprising a reverse circuit electrically connected between the power circuit selector and the reverse power circuit.

3. The in-vehicle liquid crystal display device as claimed in claim 1, wherein the temperature sensor detects an environmental temperature, and transmits a signal representing the environmental temperature to the power circuit selector.

4. The in-vehicle liquid crystal display device as claimed in claim 3, wherein a critical high temperature and a critical low temperature are input to the power circuit selector according to a normal operational temperature range of the liquid crystal display module.

5. The in-vehicle liquid crystal display device as claimed in claim 4, wherein the power circuit selector compares the environmental temperature with the critical high temperature and the critical low temperature stored therein.

6. The in-vehicle liquid crystal display device as claimed in claim 5, wherein if the environmental temperature is higher than the critical high temperature, the power circuit selector selects turns on the power circuit to make the Peltier member operate in a heat discharging state.

7. The in-vehicle liquid crystal display device as claimed in claim 5, wherein if the environmental temperature is lower than the critical low temperature, the power circuit selector turns on the reverse power circuit to make the Peltier member operate in a heat generating state.

8. The in-vehicle liquid crystal display device as claimed in claim 5, wherein if the environmental temperature is in the range between the critical high temperature and the critical low temperature, the power circuit selector turns off the Peltier member.

9. The in-vehicle liquid crystal display device as claimed in claim 1, wherein the temperature sensor detects an operational temperature of the liquid crystal display module.

10. An in-vehicle liquid crystal display device, comprising:
a temperature sensor;
a power circuit selector electrically connected to the temperature sensor;
a Peltier member;
a first power circuit and a second power circuit electrically connected in parallel between the power circuit selector and the Peltier member; and
a liquid crystal display module electrically connected to the Peltier member, and having the Peltier member operatively coupled thereto.

11. The in-vehicle liquid crystal display device as claimed in claim 10, wherein the power circuit selector selects each of the first and second power circuits to be either turned on or turned off according to an environmental temperature signal received from the temperature sensor, such that the power circuit selector controls an operational state of the Peltier member.

12. The in-vehicle liquid crystal display device as claimed in claim 11, wherein the Peltier member is configured to be in a selected one of a heat discharging state, a heat generating state, and an off state.

13. A method of operating an in-vehicle liquid crystal display device, comprising steps of:
providing a liquid crystal display module;
providing a temperature sensor detecting an environmental temperature around said liquid crystal display module; and
providing heat generating/discharging device to affect a temperature of the liquid crystal display module according to the detected environmental temperature so as to maintain the temperature of the liquid crystal display module in an operational range.

14. The method as claimed in claim 13, further comprising a step of providing different power circuits actuating said heat generating/discharging device for applying/removing heat with regard to the liquid crystal display module.

15. The method as claimed in claim 14, further a step of providing a power circuit selector for adopting said different power circuits, respectively.
